(19) United States
(12) Patent Application Publication
(10) Pub. No.: US 2026/0107267 A1
(43) Pub. Date: Apr. 16, 2026

(54) UPDATING DYNAMIC BANDWIDTH EXPANSION PARAMETERS

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US)

(21) Appl. No.: 19/281,583

(22) Filed: Jul. 26, 2025

Related U.S. Application Data
(60) Provisional application No. 63/766,892, filed on Mar. 4, 2025.
(60) Provisional application No. 63/707,640, filed on Oct. 15, 2024.

(51) Int. Cl. H04W 72/0457; H04W 72/23

(52) U.S. Cl. CPC H04W 72/0457; H04W 72/23

(57) ABSTRACT

Wireless stations (STAs) are described that announce dynamic bandwidth expansion (DBE) parameters to an access point (AP). This can occur before, or after, the AP announces the start of a DBE session. For example, the STAs can inform the AP of the particular expanded bandwidths (E-BWs) they can support (e.g., 80, 160, or 320 MHz). Using this information, the AP can determine the E-BW to announce for the DBE session. Moreover, the STA can experience conditions where it wants to change the maximum E-BW it can support, or to disable DBE, in order to, e.g., conserve power. The STA can transmit to the AP an updated message that includes changed DBE parameters.

### CROSS-REFERENCE TO RELATED APPLICATIONS

This application claims benefit of co-pending United States provisional patent application Serial No. 63/766,892 filed March 4, 2025 and co-pending United States provisional patent application Serial No. 63/707,640 filed October 15, 2024. The aforementioned related patent applications are herein incorporated by reference in their entirety.

### TECHNICAL FIELD

Embodiments presented in this disclosure generally relate to wireless stations (STAs) announcing dynamic bandwidth expansion (DBE) parameters to an access point (AP).

### BACKGROUND

In enterprise deployments, wider channel bandwidths (e.g. 80, 160 & 320 MHz) are unlikely to be deployed, because the Radio Resource Management (RRM) logic and policy for enterprise deployments prefer stability for the WLAN and hence employ frequency reuse where available spectrum bandwidth is split among neighboring APs for those APs to operate on non-overlapping channels (each with a different primary channel). RRM logic typically employs high frequency reuse (e.g., a 10+ frequency reuse pattern) leading to adoption of e.g. 20/40MHz channel bandwidth for 5GHz and 20/40/80MHz for 6GHz. High client density also discourages use of wide-channels because Enhanced Distributed Channel Access (EDCA) performance quickly degrades in HD (e.g. 100+ stations (STAs)). RRM also limits channel changes and bandwidth changes due to legacy compatibility issues observed in 2.4 and 5 GHz spectrum where some legacy STAs will roam away from the AP when a channel switch is announced or may not connect to an AP that supports channel changes/channel switch. Hence, to avoid these negative impacts of legacy devices, channel changes are typically done infrequently in enterprise WLAN networks – e.g., once every day during off-peak hours or once every 8-12 hours – to minimize legacy compatibility concerns. The load on an AP typically varies with some APs experiencing high load on a temporal basis, e.g., during a meeting the AP(s) in the conference room experience higher load because more devices are connected versus APs outside in the cubicle areas where smaller number of devices are connected. Given the increased load is temporary, but channel and bandwidth assignment are for much longer time scales (e.g. for a day), current enterprise deployments do not provide sufficient schemes to serve higher temporal loads.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless network for dynamically updating DBE parameters of a STA, according to one embodiment.

FIG. 2 is timing graph for performing DBE, according to one embodiment.

FIG. 3 is a flowchart for providing DBE parameters to an AP, according to one embodiment.

FIG. 4 is a chart that illustrates different scenarios for DBE, according to one embodiment.

FIG. 5 illustrates a frame for transmitting DBE parameters, according to one embodiment.

FIG. 6 is a flowchart for announcing DBE sessions based on received DBE parameters from a STA, according to one embodiment.

FIG. 7 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure is a wireless STA that includes one or more memories and one or more processors communicatively coupled to the one or more memories, where the one or more processors are configured to, individually or collectively, perform an operation. The operation includes identifying a maximum expanded channel bandwidth supported by the wireless station for dynamic bandwidth expansion (DBE) and transmitting, to an access point (AP), a first signal comprising the maximum expanded channel bandwidth and a DBE mode indicating that DBE is enabled at the wireless station. Moreover, the AP is configured to set a first expanded channel bandwidth based on the maximum expanded channel bandwidth received from the wireless station.

Another embodiment presented in this disclosure is an AP that includes one or more memories and one or more processors communicatively coupled to the one or more memories, where the one or more processors are configured to, individually or collectively, perform an operation. The operation includes receiving a first signal comprising a maximum expanded channel bandwidth supported by a wireless station associated with the AP, determining, based on the maximum expanded channel bandwidth, a first expanded bandwidth for a first DBE session, and transmitting a DBE announcement indicating when a first channel bandwidth is increased to the first expanded bandwidth.

Another embodiment presented in this disclosure is a method that includes identifying a maximum expanded channel bandwidth supported by the wireless station for DBE, and transmitting, to an access point (AP), a first signal comprising the maximum expanded channel bandwidth and a DBE mode indicating that DBE is enabled at the wireless station. Moreover, the AP is configured to set a first expanded channel bandwidth based on the maximum expanded channel bandwidth received from the wireless station.

### EXAMPLE EMBODIMENTS

Embodiments herein describe STAs announcing DBE parameters to an AP. For example, the STAs can inform the AP of the particular expanded bandwidths (E-BWs) they can support (e.g., 80, 160, or 320 MHz). This can occur before, or after, the AP announces the start of a DBE session. Using this information, the AP can determine the E-BW to announce for the DBE session. Also, transmitting the STAs DBE parameters early to the AP can avoid a sharp increase in overhead where the STAs rush to transmit their DBE parameters to the AP right after the AP announces the DBE session.

Moreover, the DBE parameters of the STA may change due to changing conditions. For example, a STA may not be able to support the E-BW it previously indicated as its maximum DBE E-BW due to having to save power or because of in-device coexistence (IDC) issues. Moreover, the STA may want to completely disable DBE for some time period (e.g., to save power) but then enable it later. The embodiments herein support dynamically updating DBE parameters as conditions on the STA change. This information can then help the AP to make decisions regarding the DBE session (e.g., the E-BW of the session, or whether to even initiate the session).

Before discussing STA signaling in detail, a brief introduction of DBE is provided next.

Channel Switch Announcement (CSA) or Extended CSA (E-CSA) in IEEE 802.11 standard can support changing the operating BW of a basic service set (BSS). However, using existing CSA or E-CSA to obtain more frequency or perform dynamic bandwidth change has undesirable impacts on legacy devices. For example, most legacy STAs respond to CSA/E-CSA by roaming away and then roaming back (causing double scan/roam hit). To perform BW expansion using CSA/E-CSA (e.g., every few seconds or minutes), the double roaming has a serious negative impact on the performance of the legacy STAs. In addition, some legacy STAs will not associate with an AP that supports CSA. Further, CSA/E-CSA BW changes are designed for use with RRM, which is primarily for non-real time (or longer time scale) changes to channel and BW selection, and is not expected to be used for fast/real-time/frequent BW changes (e.g., at each transmit opportunity (TXOP) level, every millisecond, every second, or every minute or every few minutes etc.). In addition, the CSA/ECSA is mainly used for changing the primary channel of the BSS, which is not the case for DBE (or RT-DBE), where the primary 20 MHz channel for the BSS remains the same and only BW changes. Using CSA/ECSA for only bandwidth changes may cause field interoperability issues with legacy devices.

To perform RT DBE, the AP and STAs exchange signals indicating their respective DBE capabilities (e.g., whether DBE is supported, maximum DBE dynamic BW supported, list of one or more dynamic BW supported, etc.). Later, the AP (or a network controller) can determine to perform DBE. For example, the load on the AP may jump because the AP is located in a conference room or an event center. To provide additional BW to serve higher loads, the AP (or the RRM logic or controller) can determine to perform a DBE operation which makes the wider channel BWs available to the AP, e.g., 80 MHz, 160 MHz or 320 MHz. To do so, the AP transmits a DBE announcement in advance to inform the STAs about an upcoming expanded BW. This announcement can include information of the expanded DBE bandwidth such as expanded DBE channel bandwidth, center frequency for the expanded BW, whether one or more sub-channels are punctured within the expanded BW, etc. and indicate the start time (or the DBE BW switch time) when the BW will be expanded. The DBE BW switch time can be indicated, e.g., as the number of target beacon transmission times (TBTTs) until the AP switches to the DBE BW or a future timing synchronization function (TSF) time when the DBE BW switch happens. The DBE announcement can be sent for certain beacon intervals in advance (before DBE BW change takes place) e.g., sent for few delivery traffic indication map (DTIM) beacon intervals or can be sent for larger number of beacon intervals based on the listen interval of associated STAs that support DBE. This enables STAs to prepare and get ready to operate at the expanded BW. In one embodiment, signaling for the advance DBE announcement can be provided as part of one or more of beacon, probe response, fast initial link setup (FILS) discovery, or (re)association response frames.

Once the BW is expanded, the AP operates with an active DBE mode or active DBE session. The AP also indicates to the STA that it is operating with DBE expanded BW (active DBE session or mode) and indicates expanded DBE bandwidth parameters to the STAs. As above, the DBE bandwidth parameters provided after BW expansion can include expanded DBE bandwidth, channel center frequency for the expanded BW, whether one or more sub channels are punctured within the expanded BW, etc. DBE bandwidth parameters provided after BW expansion can be indicated in beacon, probe response, FILS discovery or (re)association response frames. This signaling from the AP can be used to notify STAs that may have been sleeping that a DBE session or mode is currently active in the BSS.

In some embodiments, the current DBE BW remains active until the AP sends another DBE announcement to change the DBE BW or terminate the DBE session. The subsequent DBE announcement to make changes or terminate the DBE session is also announced for some time duration in advance, e.g., a certain number of beacon intervals. In some embodiments, the AP may change DBE bandwidth of a currently active DBE session to another DBE bandwidth, e.g., change DBE BW from 160 MHz to 320 MHz. The AP can achieve this by sending another DBE announcement indicating DBE bandwidth parameters for the changed DBE BW. In some embodiments, the DBE session remains active until the AP sends another DBE announcement indicating the termination of the DBE session. For example, the AP may wait until its load decreases to terminate the active DBE session. However, in another example, the original DBE announcement can include a duration indicating a start and stop time of the DBE session. After the DBE session is terminated, the AP and DBE supporting STAs return to operating at the BSS operating bandwidth.

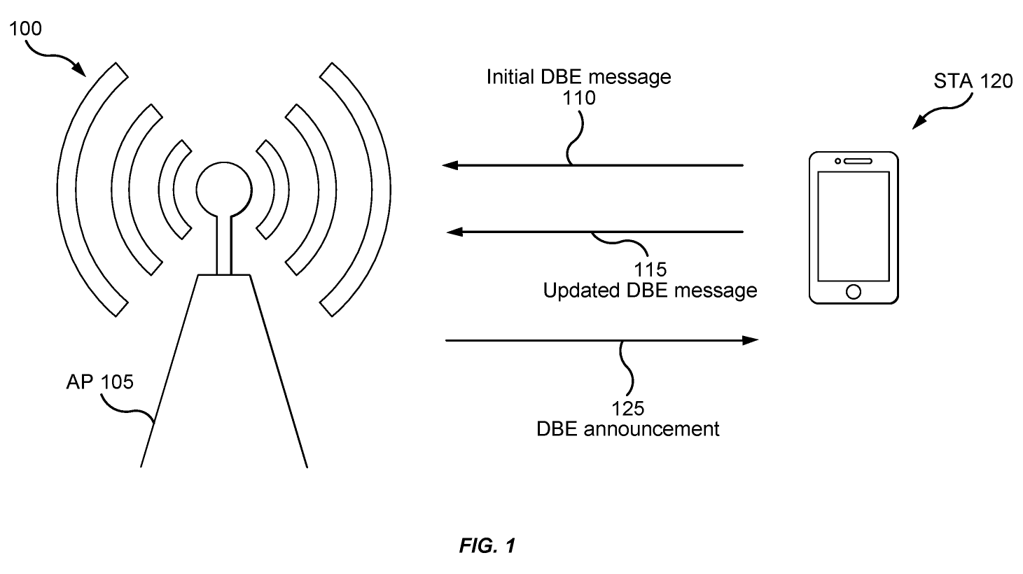

FIG. 1 illustrates a wireless network 100 for dynamically updating DBE parameters of a STA, according to one embodiment. FIG. 1 illustrates an AP 105 and a STA 120 (e.g., a mobile phone, tablet, laptop, desktop computer, etc.). It is assumed that the STA 120 has already associated with the AP 105.

FIG. 1 illustrates that the STA 120 transmits an initial DBE message 110 to the AP 105, which includes the DBE parameters for the STA 120. These DBE parameters can include the STA’s DBE Mode (e.g., set to enabled or disabled), maximum (max) DBE BW indication (indicates maximum supported DBE expanded BW and the disabled sub channels (if any) for that BW), DBE BW Switching Delay (indicates maximum switching delay for the STA 120 when switching the operating BW to the Max DBE BW), and DBE BW Switch Back Delay (indicates maximum switching delay for the STA when switching the operating BW from the expanded Max DBE BW to AP's original operating BW). These are just a few examples of DBE parameters. The DBE parameters can include more (or fewer) than the ones listed.

In one embodiment, the STA 120 may report the same delay for the DBE BW Switching Delay and the DBE BW Switch Back Delay. In that case, the DBE operating parameters may define just a single field for the DBE Switching Delay.

In the Max DBE BW indication, the STA 120 can use puncturing (disabled sub channels) to puncture out some parts of the BW that it cannot use, e.g., due to IDC issues.

In one embodiment, the DBE message 110 can include information for other E-BWs than the max DBE BW the STA 120 can support. For example, the STA 120 can provide information for E-BWs that are lower than the max DBE BW. That is, if the max DBE BW for the STA 120 is 320 MHz, the message 110 can still include the BW switching delay, switch back delay, and disabled sub channels for lower BWs (e.g., 160 and 80 MHz). That way, when the STA 120 dynamically changes DBE BW (say from 160 to 80 MHz) using A-Control signaling, then the STA 120 does not need to provide the updated switching delay(s) and Disabled sub channels (if any) for that BW since these were already provided to the AP 105 in the initial DBE message 110. In any case, the STA 120 can provide these DBE parameters as part of a DBE element/field that includes one or more of the parameters discussed above.

In one embodiment, the initial DBE message 110 is a management frame, e.g., in the (Re)Association Request frame or in a new DBE Operating Mode Notification (OMN) frame or an OMN frame defined for ultra-high reliability (UHR) (e.g., an UHR defined management frame).

As mentioned above, the STA 120 may want to change its DBE parameters. For example, the STA 120 may not be able to support the E-BW it previously indicated as its maximum DBE E-BW due to having to save power or because of IDC issues. Moreover, the STA 120 may want to completely disable DBE for some time period (e.g., to save power) but then enable it later. In that case, the STA 120 can transmit an updated DBE message 115 that indicates a change to one or more of the DBE parameters defined in the initial DBE message 110. The updated DBE message 115 can be sent before the AP enables the DBE mode or after the AP has enabled the DBE mode.

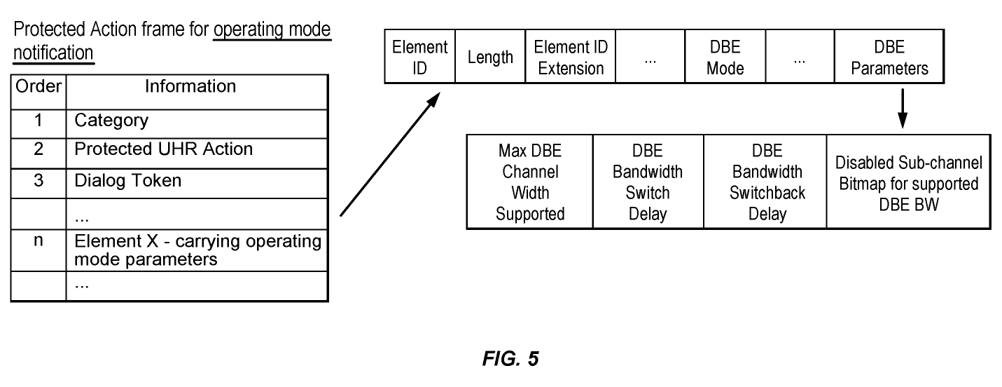

In one embodiment, the updated DBE message 115 is a newly defined management frame for signaling changes to the DBE operating mode (e.g., enabling or disabling) and changes to DBE parameters. The message 115 can be a message defined for signaling operating mode changes for one or more UHR operating modes from the STA including the DBE operating mode. In one case, the new management frame defined can be a new operating mode notification frame defined for UHR which is discussed in more detail in FIG. 5. The operating mode notification frame can be a new UHR Operating Mode Notification frame or a DBE Operating Mode Notification frame or a UHR Link Reconfiguration Request frame or a UHR Link Reconfiguration Notify frame or another management frame that indicates whether the DBE mode is enabled or disabled and indicates changes to DBE operating parameters above (e.g., max DBE BW indication and DBE BW Switching Delay parameters). In one embodiment, the operating mode notification frame can be an acknowledged action/management frame. The operating mode notification frame may have a response/confirmation frame to confirm that AP 105 has accepted the changed DBE operating parameters indicated in the frame. If no response/confirmation frame is defined, then the AP 105 can implicitly accept and apply the modified DBE operating parameters for the STA 120. In one case, a timeout value may be defined that indicates the timeout after which the updated DBE parameters for the STA become effective at the AP.

In one case, when the operating mode notification frame is a UHR Link Reconfiguration Request frame, the DBE parameters can be included in a Reconfiguration Multi-Link element, a Basic Multi-Link element, or in a new element defined in that frame. In one case, the new element carrying DBE parameters can be included in the STA Profile field of the Per-STA Profile subelement of the Reconfiguration Multi-Link element or the Basic Multi-Link element.

In another embodiment, the updated DBE message 115 can be implemented using in-band A-Control signaling. In this example, a new 'UHR OM Control' A-Control field can be defined in UHR to signal changes to operating mode parameters for UHR STAs. The UHR OM Control field can be defined to signal changes to DBE operating parameters such as the DBE Mode (e.g., a 1 bit field, set to 1 to indicate DBE is enabled and 0 to indicate DBE is disabled) and Max DBE BW (e.g., a 2 or 3 bit field, indicating modified DBE BW supported by the STA). To save bits, the UHR OM Control' field may not include disabled sub channels (if any) and the DBE BW Switching Delay for the modified BW. Instead, the STA 120 could have provided this information to the AP 105 previously using the initial DBE message 110 (e.g., (Re)Association frame or UHR OMN frame or DBE OMN frame). The AP 105 would use the disabled sub-channels (if any) and the DBE BW Switching Delay for the modified DBE BW indicated in the A-Control.

In yet another embodiment, the updated DBE message 115 can be implemented using high efficiency (HE) and extra high efficiency (EHT) A-control fields (e.g., an UHR defined A-control signal) to indicate a change in DBE parameters. The A-control fields can be used to signal the STAs max operating BW capability, which can be assumed to be the STA’s max BW capability for a DBE session. In other words, the DBE message 115 might not be explicit for DBE (e.g., a separate field for a max DBE BW) but can be implied when the STA uses an HE or EHT A-control fields to report its max BW capability.

In one case, updates to max DBE BW supported for a STA can be indicated using existing bandwidth signaling schemes defined in VHT, HE or EHT. For example, a STA can signal an updated operating bandwidth using an existing Operating Mode Notification frame already defined, or using an OMI (Operating Mode Indication) A-control signal already defined. In that case, the AP applies the updated operating bandwidth received from the STA over existing OMN or OMI mechanism as the maximum DBE BW supported for that STA.

In one case, the STA uses both an explicit message 115 to signal changes to DBE parameters and then can use existing bandwidth signaling schemes defined in VHT, HE or EHT to update its maximum operating BW which then also updates the STA’s maximum DBE BW. For example, the STA can indicate 160 MHz as its max DBE BW in message 115 and then use VHT/HE/EHT OMN or OMI mechanism to lower its operating BW to 80 MHz (e.g., for power save reason). In that case, the AP and STA would use 80 MHz as maximum BW for DBE operation. After indicating modified DBE operating parameters in a new or modified OMN frame or the UHR OM Control field (e.g., changing DBE BW from 160 to 80 MHz) or using VHT/HE/EHT OMN or OMI mechanism, both the AP 105 and the STA 120 can apply the modified DBE operating parameters in the next TxOP.

Moreover, as discussed in more detail below, the AP 105 can use the modified DBE parameters received to determine if it should make any changes to a DBE announcement 125 which can be a Beacon, Probe Response, or another management frame. Or if a DBE session is currently active, the updated DBE message 115 can be used to change how the STA and AP communicate during that session (e.g., in the next TxOP).

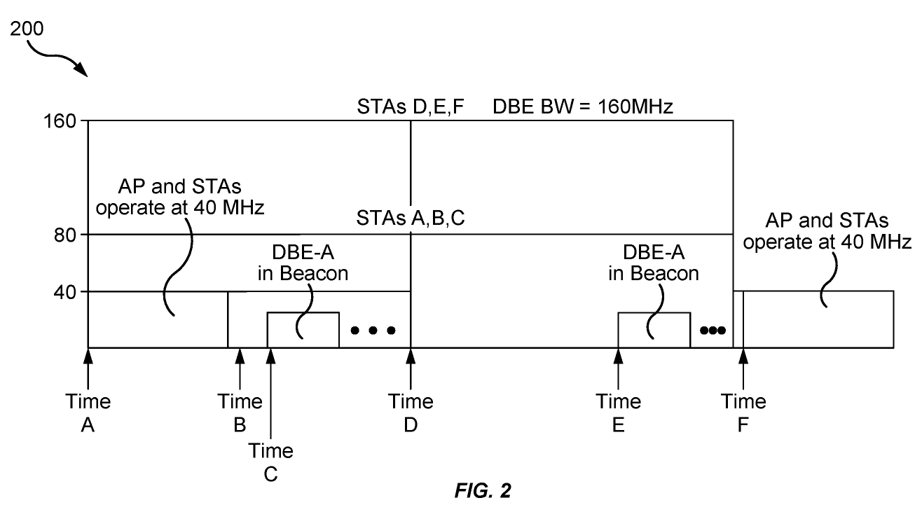

FIG. 2 is timing graph 200 for performing DBE, according to one embodiment. The y-axis of the graph 200 indicates the bandwidth of a BSS provided by an AP while the x-axis indicates time. The bandwidth of the BSS is expressed as a channel width (e.g., 40MHz, 80MHz, 160MHz, 320MHz, etc.). When deployed in an enterprise at Time A, RRM logic or some other resource management scheme can be used to assign a BSS BW to the AP. In this example, 40MHz is the default operating bandwidth of the BSS which is used by the AP and STAs in the BSS.

At Time B, the AP of RRM determines to expand the BW of the AP to be used for STAs that support expanded DBE BW operation. For example, RRM may identify an increased load at the AP (e.g., more STAs have associated with the AP or the STAs have increased BW needs) or determine to expand the BW based on reduced co-channel interference (CCI) from neighboring APs or a combination of the two, and may consider other conditions. While expanding the BW can cause neighboring APs in the deployment to potentially have overlapping sub channels which can reduce WLAN stability, the DBE BW expansion can be temporary in order to respond to increased loads (which also may be temporary).

At Time C, the AP sends out DBE announcements (e.g., the DBE announcement 125 in FIG. 1) to inform the STAs of an upcoming expanded BW DBE operation. As discussed in more detail below, the announcement informs the STAs the E-BW for the DBE session (e.g., the BW is being expanded from 40MHz to 160MHz bandwidth), channel center frequency for the DBE BW, any punctured sub channels within the DBE BW, a DBE BW switch time/start time, duration for how long DBE expanded BW operation will last, etc. This advance DBE announcement provides time for the STAs to re-calibrate their hardware for operating at the new bandwidth.

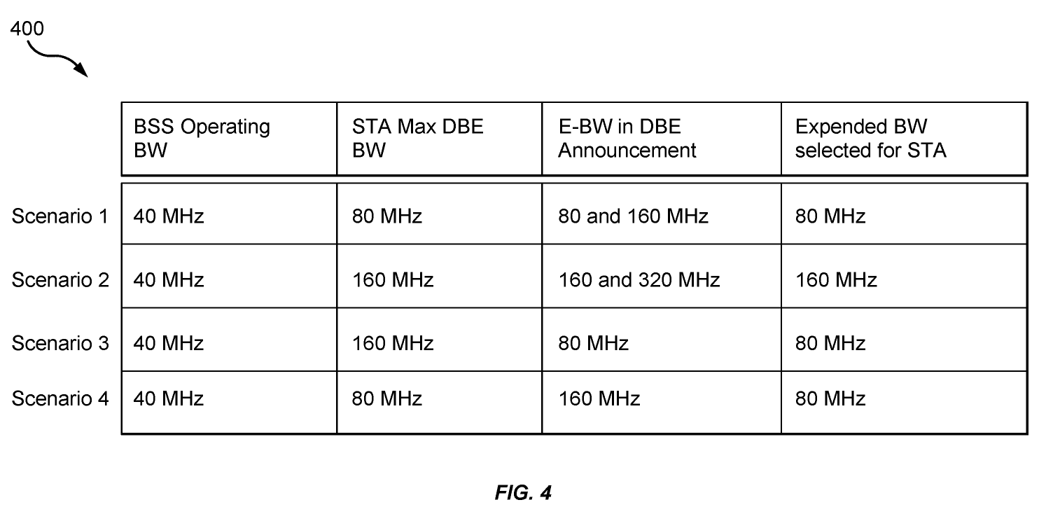

Moreover, the size of the E-BW for the DBE session may be increased based on the DBE parameters received from the STAs. That is, the AP can use the DBE parameters defined in the DBE message 110 and the updated DBE message 115 in FIG. 1 to determine whether to expand the BW to 80, 160 or 320MHz. For example, if the STAs at most support 160 MHz, then the AP may expand the BW of the BSS to 160 MHz, instead of to 320MHz (although there may be reasons to still expand the BW to 320 MHz to take advantage of dynamic sub-band operation (DSO) which is discussed in FIG. 4). Or if the AP learns from the messages 110 and 115 that several of the STAs have DBE disabled, then the AP can ignore their DBE parameters when determining the parameters for the DBE session.

At Time D, the DBE BW expansion occurs. As illustrated in FIG. 2, the BW of the AP increases to 160MHz (from 40 MHz). In some embodiments, different STAs may support different maximum DBE BWs than is supported by the AP. FIG. 2 illustrates that some STAs may utilize less than the maximum DBE dynamic BW, e.g., because they have smaller maximum DBE BW capabilities. For example, the STAs A, B, and C may only be capable of using 80MHz channel bandwidth. Nonetheless, FIG. 2 illustrates the embodiments herein permit STAs to access the increased/expanded BW, even if they cannot utilize sub channels on the entire expanded BW. In contrast, the STAs D, E, and F can utilize the entire DBE bandwidth during the expanded BW operation.

At Time E, the AP transmits a DBE announcement indicating the DBE mode/session is going to be terminated or end at Time F. As such, the AP can continue to use the expanded BW until Time F. The announcement sent at Time E (e.g., a termination or reset announcement) can be similar to the announcement sent at Time C except it indicates when the active DBE mode/session will terminate by indicating a DBE BW switch time when DBE session will terminate. This DBE announcement can indicate the termination of the DBE session using an explicit ‘DBE termination’ field or it could indicate DBE termination by setting DBE bandwidth parameters to indicate the original BSS bandwidth parameters (in this case 40 MHz, which signals to STAs that the DBE BW is being reset to the BSS BW). In either case, this DBE announcement gives the STA enough time to prepare (e.g. recalibrate their hardware) to return to the default operating BW of the BSS at the DBW BW switch time indicated.

However, in another embodiment, the AP may indicate the duration, or end time, of the DBE mode in the DBE announcement that was sent at Time C. In that scenario, the DBE mode terminates at the end of the duration or at the end time indicated in that DBE announcement, without the AP sending another announcement.

At Time F, the AP ceases using the expanded BW and returns to the default BW of the BSS (e.g., 40MHz.). After Time F, the AP and the STAs operate with the default BSS BW. Both the AP and STA can define a DBE BW Switching back delay, that defines the delay (e.g., in microseconds) for each peer to change its operating BW to the AP's previous operating BW. Both peers honor the DBE Switching back delay and do not initiate transmission to the peer STA before the DBE Switching back delay, after the DBE session has expired.

As mentioned above, the AP can provide its DBE BW switching delay and switch back delay as part of its DBE capability and parameters, e.g., in UHR Capabilities or in a DBE element included in Beacon, Probe Response, or another management frame.

Moreover, the AP may also extend or shorten the DBE duration/end time for one or more DBE sessions in a DBE announcement, based on real time measurements (CCI, load) from neighboring APs. Any changes in DBE parameters announced in Beacon, Probe Response, or another management frame may be considered critical updates and result in updating the BSS Parameters Change Count (BPCC) for that BSS. This will ensure that STAs acquire the latest DBE announced parameters from DBE announcement, and take actions accordingly.

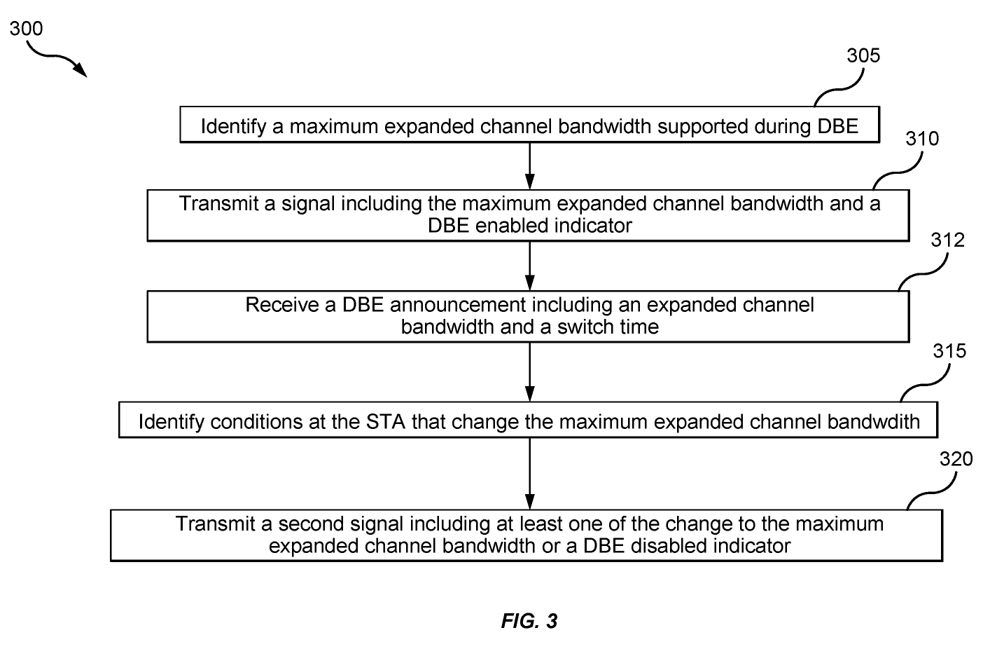

FIG. 3 is a flowchart of a method 300 for providing DBE parameters to an AP, according to one embodiment. At block 305, the STA identifies a maximum expanded channel bandwidth (e.g., a max DBE BW indication) supported during DBE. This max BW may be limited by the hardware capabilities of the STA (e.g., the radios or input/output (I/O) interfaces in the STA).

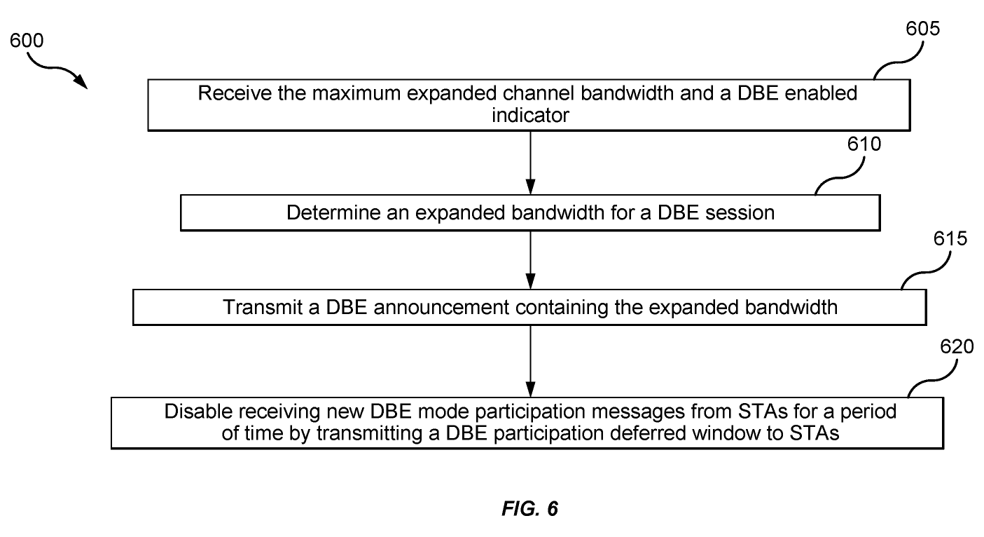

At block 310, the STA transmits a signal (e.g., the initial DBE message 110 in FIG. 1) including the maximum expanded channel bandwidth and a DBE enabled indicator to the AP. In one embodiment, the STA transmits the signal before the AP has announced the start of a DBE session. However, in other embodiments, the STA may wait to transmit the signal until after (or in response to) the AP announcing a DBE session. However, this can result in a large increase in overhead if multiple STAs transmit these signals at once. This situation is addressed in FIG. 6 below.

At block 312, the STA receives, from the AP a DBE announcement including an expanded channel bandwidth and a switch time. In one embodiment, the AP sets the expanded channel bandwidth using the maximum expanded channel bandwidth received from the STA. Moreover, the AP may set the expanded channel bandwidth based on maximum expanded channel bandwidths received from multiple STAs.

At block 315, the STA identifies conditions that change the maximum expanded channel bandwidth. For example, the STA 120 may not be able to support the E-BW it previously indicated as its maximum DBE E-BW due to having to save power or because of IDC issues. Or the STA 120 may want to completely disable DBE (e.g., disable expanded bandwidth operation) for some time period (e.g., to save power).

At block 320, the STA transmits a second signal (e.g., the updated DBE message 115) including at least one of a change to the maximum expanded channel bandwidth or the DBE mode. The second signal can either increase or decrease the maximum expanded channel bandwidth from what was indicated in the signal transmitted at block 310, or the second signal can change the DBE mode (e.g., indicate the STA has now disabled or enabled DBE), or both.

FIG. 4 is a chart 400 that illustrates different scenarios for DBE, according to one embodiment. The “BSS operating BW” column indicates the original or default operating BW of the BSS for the four scenarios provided in the four rows of the chart 400. The “STA Max DBE BW” column indicates the maximum BW the STA can support in a DBE session. The “E-BW in DBE Announcement” column indicates the E-BW announced by the AP for the DBE session. The “Expended BW selected for STA” column indicates the BW used by the STA during the DBE session.

In Scenario 1, the max DBE supported by the STA is 80 MHz, while the E-BW in the DBE announcement includes two different E-BWs: 80 and 160 MHz. Because the max DBE for the STA is 80 MHz the STA uses at most 80 MHz of the E-BW as indicated in the rightmost column. Although not shown, other STAs may support 160 MHz E-BW, in which case those STAs can use the full 160 MHz of the E-BW.

In Scenario 2, the max DBE supported by the STA is 160 MHz, while the E-BW in the DBE announcement includes two different E-BWs: 160 and 320 MHz. Because the max DBE for the STA is 160 MHz the STA uses at most 160 MHz of the E-BW as indicated in the rightmost column. Although not shown, other STAs may support 320 MHz E-BW, in which case those STAs can use the full 320 MHz of the E-BW.

In Scenario 3, the max DBE supported by the STA is 160 MHz, while the E-BW in the DBE announcement is only 80 MHz. As indicated in the rightmost column, the STA uses the 80 MHz of the E-BW even though it could support more. The AP may not provide more than 80 MHz during the DBE session because of concerns about interfering with neighboring APs.

In Scenario 4, the max DBE supported by the STA is 80 MHz, while the E-BW in the DBE announcement is 160 MHz. Because the max DBE for the STA is 80 MHz, as indicated in the rightmost column, the STA uses at most 80 MHz of the E-BW. In some situations, even if the STAs connected to the AP can only support 80 MHz of E-BW during a BDE session, the AP may still expand the BW to 160 MHz or 320 MHz. The AP can then use DSO to divide the 160 MHz BW into two 80 MHz channels (e.g., primary and secondary channels). Using DSO, the AP can assign one or more STAs to the primary 80 MHz channel and assign one more other STAs to the secondary 80 MHZ channel.

As illustrated in chart 400, a STA can select its expanded BW based on its Max DBE BW capability and DBE E-BW announcement provided by the AP. The STA selects its expanded BW to be the minimum of the STA’s Max DBE BW and the Maximum E-BW provided in the DBE announcement (assuming the DBE announcement includes multiple E-BWs as is the case in Scenarios 1 and 2). If the STA's Max DBE BW is announced in the DBE announcement, the STA operates with that E-BW (as shown in Scenarios 1 and 2 in chart 400). If the maximum E-BW in a DBE announcement is lower than the STA's Max DBE BW, then the STA operates with the Maximum E-BW in the DBE announcement as shown in Scenario 3. If the AP announces a higher E-BW than the STA's Max DBE BW, then STA operates with its Max DBE BW as shown in Scenario 4.

In one embodiment, a STA can also signal a change in its Max DBE BW during an active DBE session (e.g., when the STA and AP are already using E-BW as indicated in the Scenarios in chart 400). For example, the STA’s Max DBE BW may change from 160 to 80 MHz in order to save power. The STA could also disable DBE operation during a DBE session (perhaps to save power). Such changes to DBE operating parameters during an active DBE session can be signaled using one of the mechanism proposed above: using in-band A-Control signaling with UHR OM Control or via a UHR OMN frame (or another frame). In response, both the AP and STA can use the updated Max DBE BW from the STA to select a revised expanded BW for use in subsequent TxOPs with the DBE session. For example, if the STA’s max DBE BW changes from 160 to 80 MHz for a STA, both the STA and AP operate with 80 MHz E-BW for that STA during the subsequent TxOPs of that DBE session.

FIG. 5 illustrates an example frame for transmitting DBE parameters from the STA to the AP, according to one embodiment. In one embodiment, the frame in FIG. 5 provides DBE parameters using an Operating Mode Notification frame. The frame in FIG. 5 can be sent from the STA to the AP, e.g., as part of the messages 110 and 115 described in FIG. 1.

In one embodiment, the DBE mode and DBE parameters can be added to the Operating Mode Notification frame. As shown in FIG. 5, the Protected Action frame for operating mode notification can include an Element X at order <n> (where n is based on other fields/subelements/elements included in the frame) that provides operating mode parameters for DBE to the AP, indicating for the STA.

The DBE mode indicates whether DBE is enabled/disabled for the STA.

In addition, the DBE parameters includes one or more fields which can include one or more of the max DBE channel width supported, DBE bandwidth switch delay, DBE bandwidth switchback delay, a disabled sub-channel bitmap for supported DBE BW. However, these fields are optional, and in some embodiments, some or all of these fields may not be included. For example, if the DBE mode is disabled, then the max DBE channel width supported and other fields may be omitted.

In one embodiment, the BW switch delay parameters can be specified in units of 128usec/256usec/512usec/1 time unit (TU). In one embodiment, the STA may also optionally indicate any disabled sub-channels, e.g., due to coexistence or peer-2-peer (P2P) use, using a disabled sub-channel bitmap in the expanded BW.

The STA can enable its participation in DBE operation by sending a frame with DBE Mode=1. To disable its participation, the STA can send another frame with DBE Mode = 0. In one case, STA may use A-Control signaling to enable/disable DBE participation. In one case if STA lowers it operating BW to be same or lower than the BSS bandwidth, using A-Control signal, then DBE mode becomes disabled for that STA. If STA changes its operating BW to greater than the BSS bandwidth, then DBE mode can become enabled.

In one embodiment, the frame in FIG. 5 can be mapped to a UHR Link Reconfiguration Request frame which carries additional DBE operating parameters in an element defined to carry operating mode parameters for one or more UHR operating modes (including DBE), which was discussed previously. In one case, the element that carriers the DBE parameters can be a Reconfiguration Multi-Link element or a Basic Multi-Link element. In one case, DBE parameters are carried in the Per-STA Profile subelement in the multi-link element as part of the STA Profile field in a new element defined to carry operating mode parameters.

FIG. 6 is a flowchart of a method 600 for announcing DBE sessions based on received DBE parameters from a STA, according to one embodiment. As mentioned above, if the STAs in a BSS wait until receiving a DBE announcement from the AP before transmitting their DBE parameters to the AP, it can result in a sharp increase of overhead that must be processed by the AP. Further, it may be advantageous for the AP to have the STAs’ DBE parameters before the AP announces a DBE session so the AP can tailor the E-BW of the DBE session to match the capabilities of the STAs (as discussed in FIG. 4). The method 600 provides techniques for an AP to incentive STAs to send their DBE parameters before a DBE is announced by the AP.

At block 605, the AP receives the maximum expanded channel bandwidth and a DBE enabled indicator from at least one STA in the BSS. That is, at least one STA informs the AP that it has DBE enabled and its max supported E-BW. However, there may be other STAs in the BSS that have not yet told the AP their DBE parameters.

At block 610, the AP determines an expanded bandwidth for a DBE session. For example, the AP may determine the E-BW based on the maximum expanded channel bandwidth received at block 605. For instance, if the STAs only support 80 MHz of E-BW (even though the AP can support 320 MHz), the AP may set the E-BW for the DBE session to 80 MHz since doing so may limit interference generated by the AP and STAs at neighboring APs.

At block 615, the AP transmits a DBE announcement containing the expanded bandwidth. This transmission can be received by the STAs that have, and have not, send DBE parameters to the AP.

At block 620, the AP disables receiving new DBE mode participation messages from STAs for a period of time by transmitting a DBE participation deferred window to STAs. In one example, the AP announces a ‘New DBE Participation Deferred Window’ indicating numbers of beacon intervals during which new DBE participation is not accepted as part of DBE related policy in UHR operation or another element. Thus, any STA that has not yet transmitted its DBE parameters to the AP cannot participate in the announced DBE session.

As such, any STA that receives the New DBE Participation Deferred Window knows that it missed out on the DBE session. This creates an incentive for these STAs to enable DBE participation in advance so it can participate in the next DBE session.

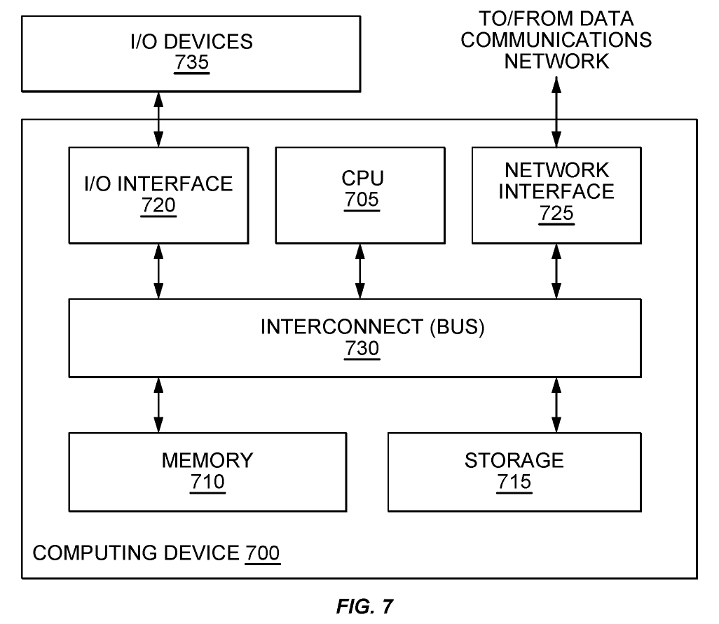

FIG. 7 depicts an example computing device configured to perform various aspects of the present disclosure, according to one embodiment. Although depicted as a physical device, in embodiments, the computing device 700 may be implemented using virtual device(s), and/or across a number of devices (e.g., in a cloud environment). In one embodiment, the computing device 700 corresponds to a network device (e.g., a computing system), such as the APs or the STAs (e.g., user devices) mentioned above.

As illustrated, the computing device 700 includes a CPU 705 (one or more processors), memory 710 (or memories), storage 715, a network interface 725, and one or more input/output (I/O) interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

The memory 710 can include software programs or application for performing DBE as discussed above in FIGS. 1-6. Although shown as residing in memory 710, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless station comprising:
one or more memories; and
one or more processors communicatively coupled to the one or more memories, wherein the one or more processors are configured to, individually or collectively, perform an operation comprising:
identifying a maximum expanded channel bandwidth supported by the wireless station for dynamic bandwidth expansion (DBE); and
transmitting, to an access point (AP), a first signal comprising the maximum expanded channel bandwidth and a DBE mode indicating that DBE is enabled at the wireless station, wherein the AP is configured to set a first expanded channel bandwidth based on the maximum expanded channel bandwidth received from the wireless station.

2. The wireless station of claim 1, wherein the operation further comprises:
identifying at least one of:
a change to the maximum expanded channel bandwidth supported by the wireless station for DBE, or
a change to the DBE mode; and
transmitting, to the AP, a second signal comprising at least one of the change to the maximum expanded channel bandwidth or the DBE mode.

3. The wireless station of claim 2, where the change to the DBE mode comprises changing the DBE mode to indicate that the DBE is disabled at the wireless station.

4. The wireless station of claim 3, wherein each of the first signal and second signal is part of a management frame.

5. The wireless station of claim 4, wherein the management frame further comprises at least one of:
a DBE switching delay indicating a switching delay for the wireless station when switching from an operating bandwidth of a basic service set (BSS) to the maximum expanded channel bandwidth;
a DBE switch back delay indicating a switching delay for the wireless station when switching from the maximum expanded channel bandwidth to an operating bandwidth of the BSS; or
an indication of punctured sub channels at the wireless station within the maximum expanded channel bandwidth.

6. The wireless station of claim 4, wherein the management frame is defined for ultra-high reliability (UHR).

7. The wireless station of claim 2, wherein the first signal indicates the maximum expanded channel bandwidth supported by the wireless station in an operating mode notification frame or an in-band A-control signal.

8. The wireless station of claim 7, wherein the second signal indicates the change to the maximum expanded channel bandwidth supported by the wireless station in an operating mode notification frame or an in-band A-control signal.

9. The wireless station of claim 8, wherein:
the operating mode notification frame is a management frame defined for UHR or the Operating Mode Notification frame, and
the in-band A-control signal is an ultra-high reliability (UHR) defined A-control signal or an Operating Mode Indication (OMI) A-Control signal.

10. The wireless station of claim 9, further comprising disabling DBE operation by updating the maximum expanded channel bandwidth supported by the wireless station to a BSS operating bandwidth or lower.

11. The wireless station of claim 1, wherein the operation comprises:
receiving, after transmitting the signal, a DBE announcement from the AP, the DBE announcement comprising the first expanded channel bandwidth and a switch time when an operating bandwidth will increase by the first expanded channel bandwidth.

12. The wireless station of claim 1, wherein the operation comprises:
receiving, before transmitting the signal, a DBE announcement from the AP, the DBE announcement comprising:
a first expanded channel bandwidth;
a switch time when an operating bandwidth will increase by the first expanded channel bandwidth; and
a deferral delay indicating a time the wireless station must wait to transmit the signal until the AP will permit the wireless station to participate in DBE.

13. An access point (AP) comprising:
one or more memories; and
one or more processors communicatively coupled to the one or more memories, wherein the one or more processors are configured to, individually or collectively, perform an operation comprising:
receiving a first signal comprising a maximum expanded channel bandwidth supported by a wireless station associated with the AP;
determining, based on the maximum expanded channel bandwidth, a first expanded bandwidth for a first dynamic bandwidth expansion (DBE) session; and
transmitting a DBE announcement indicating when a first channel bandwidth is increased to the first expanded bandwidth.

14. The AP of claim 13, wherein the operations further comprises:
receiving a second signal comprising a change to the maximum expanded channel bandwidth supported by the wireless station when the AP is operating with the first expanded bandwidth;
determining, based on the changed maximum expanded channel bandwidth, a second expanded bandwidth for a second DBE session, wherein the second expanded bandwidth is different from the first expanded bandwidth; and
transmitting a second DBE announcement indicating when a channel bandwidth is increased to the second expanded bandwidth.

15. The AP of claim 14, wherein the operations further comprises:
receiving a second signal comprising a change to the maximum expanded channel bandwidth supported by the wireless station when AP is not operating with an expanded bandwidth;
determining, based on the changed maximum expanded channel bandwidth, an expanded bandwidth for a second DBE session; and
transmitting a second DBE announcement indicating when the first channel bandwidth is increased to the expanded bandwidth for the second DBE session.

16. The AP of claim 15, wherein the operations further comprises:
receiving, from a wireless STA, the changed maximum expanded channel bandwidth in at least one of:
a UHR defined management frame for operating mode notification,
an Operating Mode Notification (OMN) frame,
an Operating Mode Indication (OMI) A-Control signal, or
an ultra-high reliability (UHR) defined A-control signal.

17. The AP of claim 16, wherein the operations further comprises using a latest received maximum expanded channel bandwidth from the wireless station for expanded bandwidth operation for that wireless STA.

18. The AP of claim 17, wherein the operations further comprises disabling the expanded bandwidth operation for that wireless STA, if the latest received maximum expanded channel bandwidth from the wireless station is equal to or smaller than a BSS operating bandwidth.

19. The AP of claim 15, wherein the operation further comprises:
disabling receiving new DBE mode participation messages from wireless stations for a period of time after transmitting the DBE announcement.

20. A method comprising:
identifying a maximum expanded channel bandwidth supported by a wireless station for dynamic bandwidth expansion (DBE); and
transmitting, to an access point (AP), a first signal comprising the maximum expanded channel bandwidth and a DBE mode indicating that DBE is enabled at the wireless station, wherein the AP is configured to set a first expanded channel bandwidth based on the maximum expanded channel bandwidth received from the wireless station.
